(19) United States
(12) Patent Application Publication
(10) Pub. No.: US 2026/0179350 A1
(43) Pub. Date: Jun. 25, 2026

(54) OUTPUT APPARATUS, OUTPUT METHOD, AND PROGRAM

(71) Applicant: Rakuten Group, Inc., Tokyo (JP)

(72) Inventor: Yeongnam CHAE, Tokyo (JP)

(73) Assignee: Rakuten Group, Inc., Tokyo (JP)

(21) Appl. No.: 18/714,779

(22) PCT Filed: Feb. 14, 2023
(86) PCT No.: PCT/JP2023/004934

§ 371 Date: May 30, 2024

(51) Int. Cl. G06V 10/44; G06N 3/08; G06N 3/084; G06N 20/00

(52) U.S. Cl. CPC G06V 10/454; G06N 3/08; G06N 3/084; G06N 20/00

(57) ABSTRACT

There is provided an output apparatus including an acceptance unit which accepts input of a shot image of a target of detection, a determination unit which determines information related to projective transformation of the target of detection by inputting the image into a learning model, and an output unit which outputs the information related to the projective transformation determined by the determination unit.

### TECHNICAL FIELD

The present invention relates to an output apparatus, an output method, and a program.

### BACKGROUND ART

It is known that a homography matrix can be calculated by extracting feature points from two images and matching the extracted feature points with each other. For example, Patent Literature 1 describes an image processing apparatus which extracts a pair of feature points from two images and calculates a homography matrix using the extracted feature points.

### CITATION LIST

### Patent Literature

Patent Literature 1: Japanese Patent Laid-Open No. 2013-214155

### SUMMARY OF INVENTION

### Technical Problem

For example, the idea of detecting presence or absence of deformation in a target of detection by extracting a feature point of the target of detection from a shot image with the target of detection appearing therein and comparing the extracted feature point with a feature point of the target of detection in a correct shape is conceivable for checking whether the target of detection appearing in the image is deformed. However, if an image has low resolution or the image is a noisy image at the time of extracting a feature point from the image as in the technique described in Patent Literature 1, a failure in feature point matching may occur to prevent appropriate recognition of presence or absence of deformation.

Under the circumstances, the present disclosure has as its object to provide an output apparatus, an output method, and a program which allow more appropriate determination as to whether a target of detection appearing in a shot image is deformed.

### Solution to Problem

An output apparatus according to one aspect of the present invention includes an acceptance unit which accepts input of a shot image of a target of detection, a determination unit which determines information related to projective transformation of the target of detection by inputting the image into a learning model, and an output unit which outputs the information related to the projective transformation determined by the determination unit.

### Advantageous Effect of Invention

According to the present disclosure, it is possible to provide an output apparatus, an output method, and a program which allow more appropriate determination as to whether a target of detection appearing in a shot image is deformed.

### BRIEF DESCRIPTION OF DRAWINGS

FIG. 1 is a diagram showing one example of an image determination system according to the present embodiment.

FIG. 2 is a view showing examples of projective transformation of a logo.

FIG. 3 is a diagram showing an example of a hardware configuration of an information processing apparatus.

FIG. 4 is a diagram showing an example of a functional block configuration of the information processing apparatus.

FIG. 5 is a diagram showing an outline of a learning model.

FIG. 6 is a flowchart showing an outline of a procedure when the information processing apparatus causes a learning model to learn.

FIG. 7 is a flowchart showing an outline of a procedure when the information processing apparatus determines projective transformation information from an image.

FIG. 8 is a diagram showing a learning model (specific example 1).

FIG. 9 is a diagram showing a learning model (specific example 2).

FIG. 10 is a view showing four patterns of projective transformation.

FIG. 11 is a diagram showing a learning model (specific example 3).

FIG. 12 is a view for explaining feature points of a target of detection.

FIG. 13 is a view showing one example of feature points after projective transformation.

### DESCRIPTION OF EMBODIMENT

An embodiment of the present invention will be described with reference to the accompanying drawings. Note that components denoted by identical reference characters in the drawings have identical or similar configurations.

### <System Configuration>

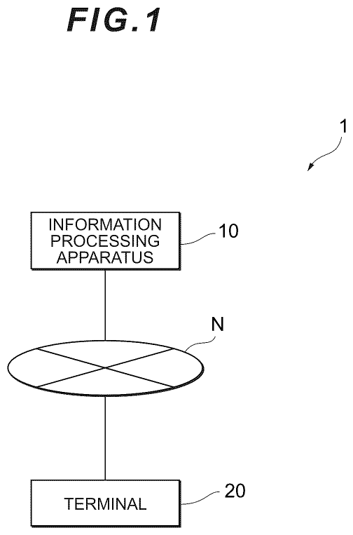

FIG. 1 is a diagram showing one example of an image determination system according to the present embodiment. The image determination system 1 includes an information processing apparatus 10 and a terminal 20. The information processing apparatus 10 and the terminal 20 are connected via a wireless or wired communication network N and can intercommunicate with each other.

The information processing apparatus 10 is an apparatus which outputs information related to projective transformation (homography transformation) indicating how a target of detection appearing in an image has been projectively transformed from an original shape of the target of detection. A target of detection has a shape determined in advance, and examples of the target of detection include a logo, a mark, a symbol, an icon, a sign, text, and the like. An original shape of the target of detection may be called a correct shape of the target of detection. Although a case where a target of detection is a logo will be taken as an example in the following description, the present embodiment is not limited to this.

Information related to projective transformation may be, for example, information indicating a method of projective transformation or information indicating whether a shape of a target of detection has been projectively transformed. The information indicating the method of projective transformation may be, for example, values of elements in a homography matrix (projective transformation matrix), information indicating a way of projective transformation (e.g., rotating an image 30 degrees in a clockwise direction), or information indicating coordinates of a plurality of feature points in the target of detection.

The information processing apparatus 10 may be composed of one or a plurality of physical servers or the like, may be constructed using a virtual server which operates on a hypervisor, or may be constructed using a cloud server.

The terminal 20 is a terminal to be operated by a user who uses the image determination system and is, for example, a personal computer (PC), a notebook PC, a smartphone, a tablet terminal, a cellular phone handset, or the like. Various types of data output from the information processing apparatus 10 are displayed on a screen of the terminal 20. The user can operate the information processing apparatus 10 via the terminal 20.

When an image with a target of detection appearing therein is input, the information processing apparatus 10 determines information related to projective transformation using a learning model which is trained to output information related to projective transformation.

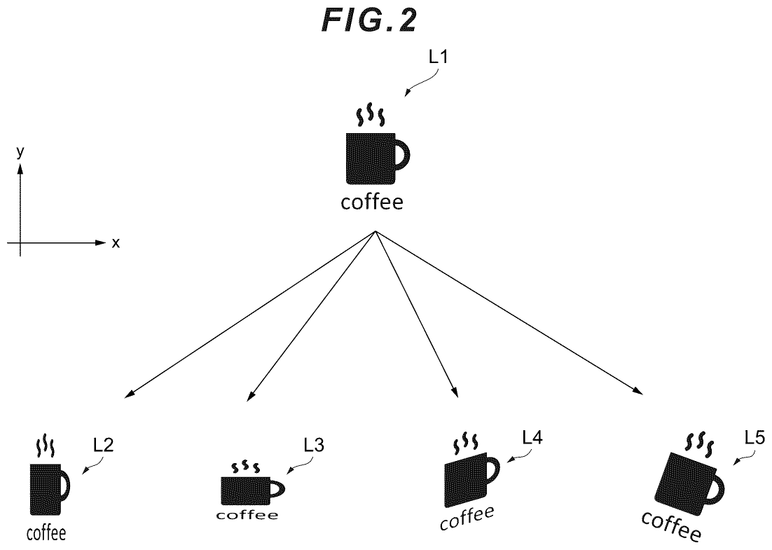

FIG. 2 is a view showing examples of projective transformation of a logo. A logo L1 indicates a correct shape of a logo. A logo L2 indicates a state after the logo L1 is scaled down in an x-axis direction. A logo L3 indicates a state after the logo L1 is scaled down in a y-axis direction. A logo L4 indicates a state after the logo L1 is sheared (skewed) in the y-axis direction. A logo L5 indicates a state after the logo L1 is rotated.

The image determination system 1 may be used for an arbitrary purpose. For example, the image determination system 1 may be used by a company to confirm whether a logo thereof is appropriately used by a different company. For example, assume a case where company B that is a business connection of company A posts logo A indicating service A of company A in the front of a store or places logo A on a printed matter. Also assume that logo A is identical to the logo L1 in FIG. 2. Although company A wants company B to use logo A in a correct shape in the use of logo A, company B may use logo A in a slightly distorted state (e.g., the state of the logo L2) due to an error in printing. In this case, a user of company A can easily find a case where logo A is used in a deformed state, using the image determination system 1.

### <Hardware Configuration>

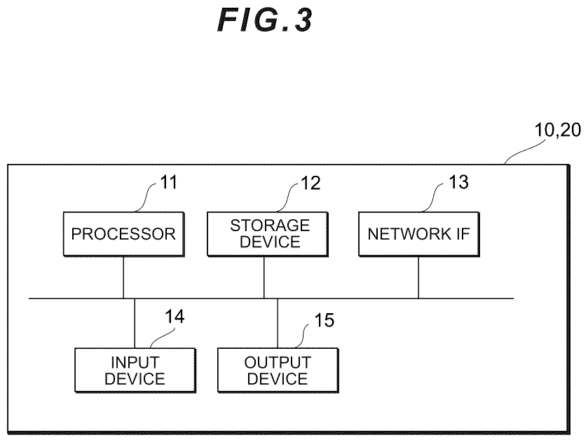

FIG. 3 is a diagram showing an example of a hardware configuration of the information processing apparatus 10. The information processing apparatus 10 has a processor 11, such as a CPU (Central Processing Unit) or a GPU (Graphical Processing Unit), a storage device 12, such as a memory (e.g., a RAM or a ROM), an HDD (Hard Disk Drive), and/or an SSD (Solid State Drive), a network IF (network interface) 13 which makes wired or wireless communication, an input device 14 which accepts an input operation, and an output device 15 which outputs information. The input device 14 is, for example, a keyboard, a touch panel, a mouse, and/or a microphone. The output device 15 is, for example, a display, a touch panel, and/or a speaker.

### <Functional Block Configuration>

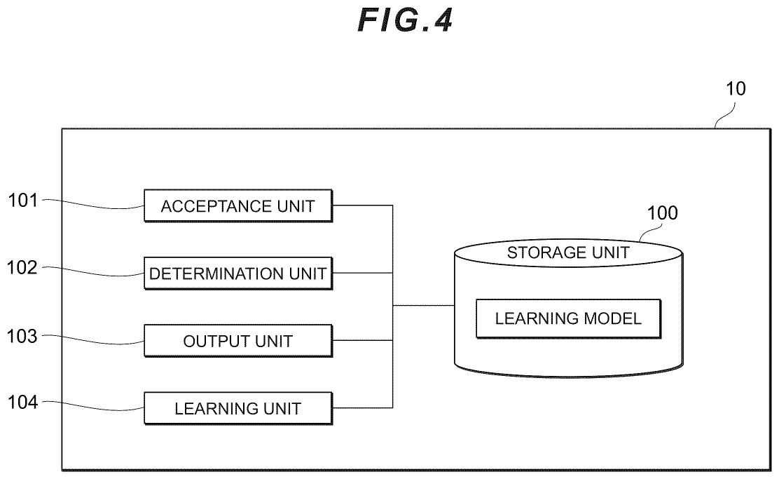

FIG. 4 is a diagram showing an example of a functional block configuration of the information processing apparatus 10. The information processing apparatus 10 includes a storage unit 100, an acceptance unit 101, a determination unit 102, an output unit 103, and a learning unit 104. The storage unit 100 can be implemented using the storage device 12 that the information processing apparatus 10 includes. The acceptance unit 101, the learning unit 104, and the output unit 103 can be implemented through execution of a program which is stored in the storage device 12 by the processor 11 of the information processing apparatus 10. The program can be stored in a storage medium. The storage medium storing the program may be a non-transitory computer readable medium. Although the non-transitory storage medium is not particularly limited, the non-transitory storage medium may be, for example, a storage medium, such as a USB (Universal Serial Bus) memory or a CD-ROM (Compact Disc Read-Only Memory).

The storage unit 100 stores a learning model. Information determining a model structure and various types of parameter values are included in the learning model.

The acceptance unit 101 accepts input of a shot image of a target of detection. For example, the acceptance unit 101 may accept input of image data via the terminal 20. The acceptance unit 101 may be called an input unit.

The determination unit 102 determines information related to projective transformation of a target of detection by inputting an image accepted by the acceptance unit 101 into a learning model. The learning model may be a model using a neural network. The determination unit 102 may determine a display position of a bounding box (hereinafter referred to as a BBOX (Bounding Box)) indicating a position where the target of detection is present on the image by inputting the image into the learning model.

The determination unit 102 may determine a type of a target of detection appearing in an image by inputting the image into the learning model. The type of the target of detection may be called a class of the target of detection. If the learning model has the ability to detect one type of target of detection, the determination unit 102 may determine, as a type of a target of detection, information indicating whether the one type of target of detection appears in an image. If the learning model has the ability to detect two or more types of targets of detection, the determination unit 102 may determine, as a type of a target of detection, information indicating which target of detection appears in an image.

The output unit 103 outputs information related to projective transformation determined by the determination unit 102. The output unit 103 may display the information related to the projective transformation on the screen of the terminal 20. The output unit 103 may output a display position of a BBOX determined by the determination unit 102. The output unit 103 may display a BBOX superimposed on an image. The output unit 103 may output a type of a target of detection determined by the determination unit 102.

The output unit 103 may output information indicating whether a shape of a target of detection has been projectively transformed or information indicating whether the shape of the target of detection has been transformed from an original shape, on the basis of information related to projective transformation determined by the determination unit 102.

The learning unit 104 causes the learning model to learn using teaching data in which a shot image of a target of detection is associated with information related to projective transformation of the target of detection.

### <Procedure>

A procedure to be performed by the information processing apparatus 10 will be specifically described.

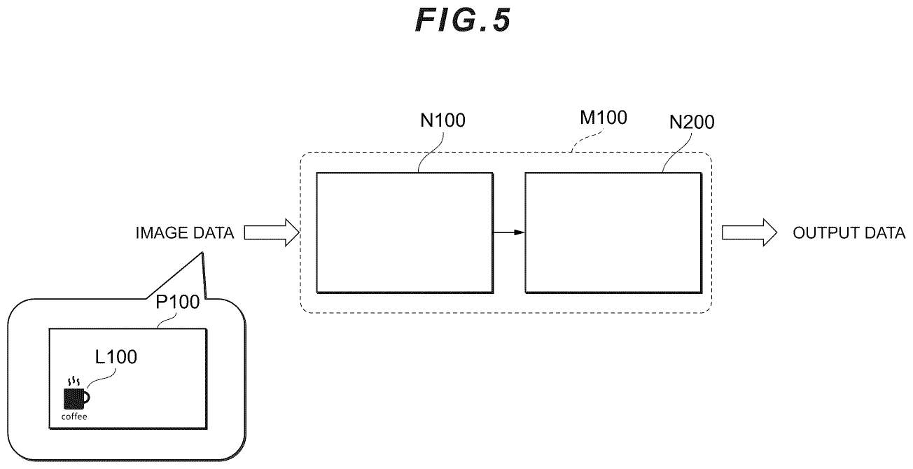

FIG. 5 is a diagram showing an outline of a learning model. Assume in FIG. 5 that a target of detection is a logo L100. A learning model M100 is a model using a neural network, and a structure of the model may be a structure in which two neural networks, a network N100 and a network N200, are connected.

The network N100 may be a network which has the ability to extract a region candidate for an object appearing in an input image. The network N200 may be a network which has the ability to output information (hereinafter referred to as “projective transformation information”) related to projective transformation of a target of detection from the region candidate extracted by the network N100.

More specifically, the network N100 may have the ability to extract a region (region candidate) where an object of some kind is estimated to appear in the entire image. For example, if an image P100 with the logo L100 appearing therein is input, the network N100 may recognize a background region and a region where an object of some kind appears in the entire image P100 and extract the region where the object of some kind appears (a region where the logo L100 appears, here) as a region candidate. The network N200 may output, from the region candidate extracted by the network N100, projective transformation information indicating how the logo L100 appearing in the region candidate has been transformed from an original shape.

Note that the network N200 may further output class information indicating a type of a target of detection appearing in the region candidate from the region candidate extracted by the network N100. For example, if the image P100 is input, the network N200 may output information indicating that a target of detection appearing in the image P100 is the logo L100. The network N200 may further output BBOX information indicating a region where the target of detection appears in the image P100 from the region candidate extracted by the network N100.

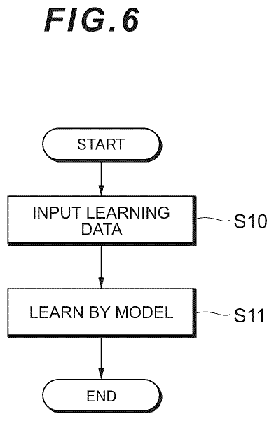

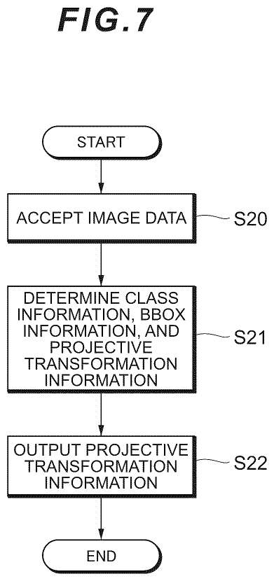

FIG. 6 is a flowchart showing an outline of a procedure when the information processing apparatus 10 causes a learning model to learn. Note that although the learning model is assumed to output three pieces of information, class information, BBOX information, and projective transformation information, in the description of FIGS. 6 and 7, the learning model is not limited to this. For example, the learning model may output only projective transformation information.

The acceptance unit 101 accepts input of learning data via the terminal 20 (S10). The learning data (also referred to as teaching data) is data in which image data of an image with a target of detection appearing therein is associated with a class of the target of detection, a display position of a BBOX, and projective transformation information.

The learning unit 104 then generates a learning model by causing a model to learn using the learning data (S11). When the learning by the model is completed, the learning unit 104 stores various types of parameters as a learning result in the storage unit 100.

FIG. 7 is a flowchart showing an outline of a procedure when the information processing apparatus 10 determines projective transformation information from an image.

The acceptance unit 101 accepts input of image data from a user via the terminal 20 (S20).

The determination unit 102 then inputs the image data into a learning model and acquires information indicating a class, BBOX information, and projective transformation information from the learning model, thereby determining the class information, the BBOX information, and the projective transformation information.

The output unit 103 outputs the class information, the BBOX information, and the projective transformation information determined by the determination unit 102 on the screen of the terminal 20. Note that the output unit 103 may transmit the class information, the BBOX information, and the projective transformation information to a different information processing apparatus instead of outputting the pieces of information to the terminal 20.

### SPECIFIC EXAMPLES

A plurality of specific examples of a configuration of a learning model will be described. Assume in the specific examples below that a learning model is a neural network obtained by providing a neural network called Faster R-CNN (Regions with Convolutional Neural Networks) with the ability to output projective transformation information. Also assume that a target of detection is a logo shown in FIG. 2.

### Specific Example 1

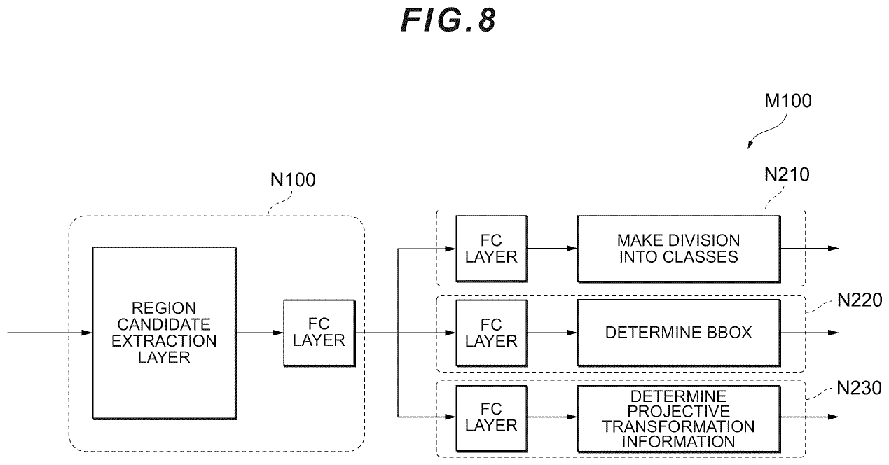

FIG. 8 is a diagram showing a learning model (specific example 1). An FC layer refers to a fully connected layer. When an image is input into the network N100, the learning model M100 in specific example 1 may output, as projective transformation information, elements of a homography matrix (projective transformation matrix) which is estimated to have been applied to a logo (target of detection) before projective transformation from a network N230 which is connected to the network N100.

The learning model M100 may include a network N210 which is connected to the network N100 and determines a BBOX surrounding a logo (target of detection) from a region candidate for an object and a network N220 which is connected to the network N100 and determines a type of the logo (target of detection) from the region candidate for the object. In this case, the determination unit 102 may determine a BBOX and a type of a target of detection by inputting an image into the learning model, and the output unit 103 may output the BBOX and the type of the target of detection determined by the determination unit 102 (the same applies to specific example 2 (to be described later)).

In specific example 1, the network N100 and the network N230 may be called a first network and a second network, respectively. The network N210 and the network N220 may be called a third network and a fourth network, respectively.

Letting (x,y) be coordinates on an image before projective transformation; (x′,y′), coordinates on the image after the projective transformation; and H, a homography matrix, the coordinates (x′,y′) can be expressed by Expression (1). The homography matrix can be expressed by Expression (2). Note that s=h₃₁×x+h₃₂×y+h₃₃ holds according to Expression (1). It is known that a value of h₃₃ in Expression (2) may be 1.

$$[ Expression 1 ]$$

$$s [ \begin{matrix}{x}^{′} \\ {y}^{′} \\ 1\end{matrix} ] = H [ \begin{matrix}x \\ y \\ 1\end{matrix} ] \qquad ( 1 )$$

$$[ Expression 2 ]$$

$$H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] \qquad ( 2 )$$

That is, the learning model M100 may be a model which outputs nine elements (h₁₁ to h₃₃) of the homography matrix that is estimated to have been applied to a logo. Alternatively, if h₃₃ is set to 1, the learning model M100 may be a model which outputs eight elements (h₁₁ to h₃₂) of the homography matrix.

Learning by the learning model M100 in specific example 1 may be performed by the following procedure. First, the learning unit 104 generates a homography matrix by randomly generating nine elements. At this time, h₃₃ may always be set to “1.” The learning unit 104 then generates an image obtained by combining a logo image which is projectively transformed using the generated homography matrix with a background image without the logo image. The learning unit 104 generates learning data which has the generated image as input data and has, as output data, class information corresponding to the logo image, a position of a BBOX indicating a region where the logo image is present in the image, and the nine elements of the homography matrix used at the time of the projective transformation of the logo image. Note that the class information and the position of the BBOX may be designated by a user who generates the learning model. The learning unit 104 generates a large number of learning data by repeating the process of generating learning data.

Then, the learning unit 104 causes the learning model M100 to learn using the large number of learning data generated. Although, for example, RMSLE (Root Mean Squared Logarithmic Error) using a mean squared error may be used as a loss function used for learning, the loss function is not limited to this.

As for the above-described learning by the learning model M100, a logo image after projective transformation may represent an inappropriate shape, such as a dot shape, depending on elements of a generated homography matrix. Since nine elements of a homography matrix need to be varied, the amount of learning data may become enormous. Thus, learning data may be configured not to include element values which cause a logo image after projective transformation to represent an inappropriate shape.

Note that, if a company uses the information processing apparatus 10 to confirm whether a logo thereof is appropriately used by a different company, as described above, patterns in which the logo is deformed are assumed to be limited to deformations which can be expressed by linear transformation, such as rotation, scaleup, scaledown, and shearing.

Letting (x,y) be coordinates on an image before linear transformation; (x′,y′), coordinates on the image after the linear transformation; and L, a matrix representing linear transformation, the coordinates (x′,y′) can be expressed by Expression (3). The matrix representing linear transformation can be expressed by Expression (4).

$$[ Expression 3 ]$$

$$[ \begin{matrix}{x}^{′} \\ {y}^{′}\end{matrix} ] = L [ \begin{matrix}x \\ y\end{matrix} ] \qquad ( 3 )$$

$$[ Expression 4 ]$$

$$L = [ \begin{matrix}{l}_{11} & {l}_{12} \\ {l}_{21} & {l}_{22}\end{matrix} ] \qquad ( 4 )$$

Note the matrix representing linear transformation can also be expressed by setting the elements h₁₃, h₂₃, h₃₁, and h₃₂ of the nine elements of the homography matrix indicated in Expression (2) to 0 and setting the element h₃₃ to 1. In this case, the elements h₁₁ to h₂₂ of the homography matrix correspond to elements l₁₁ to l₂₂, respectively, in Expression (4).

Since the number of elements of the matrix representing linear transformation is four, as indicated in Expression (4), the amount of learning data required for learning by the learning model M100 can be largely reduced, as compared with the case of estimating nine elements.

For the above-described reason, the determination unit 102 may determine information related to linear transformation of a target of detection (hereinafter referred to as “linear transformation information”) by inputting an image into the learning model. The learning model M100 may be a neural network including the network N100 that extracts a region candidate for an object appearing in an image and the network N230 that outputs linear transformation information of a logo (target of detection) from the region candidate for the object. Linear transformation information to be output from the learning model M100 may be four elements (l₁₁ to l₂₂ in Expression 4 or h₁₁ to h₂₂ in Expression 2) of the matrix representing linear transformation applied to a logo.

Learning by the learning model M100 in this case may be performed by the following procedure. First, the learning unit 104 generates a homography matrix (or a matrix representing linear transformation) by randomly generating four elements (h₁₁ to h₂₂ in Expression 2 or l₁₁ to l₂₂ in Expression 4). The learning unit 104 then generates an image obtained by combining a logo image which is projectively transformed using the generated homography matrix (or the matrix representing linear transformation) with a background image without the logo image. The learning unit 104 generates learning data which has the generated image as input data and has, as output data, class information corresponding to the logo image, a position of a BBOX indicating a region where the logo image is present in the image, and the four elements of the homography matrix (or the matrix representing linear transformation) used at the time of the linear transformation of the logo image. Note that the class information and the position of the BBOX may be designated by a user who generates the learning model. The learning unit 104 generates a plurality of learning data by repeating the process of generating learning data. The learning unit 104 causes the learning model M100 to learn using the plurality of learning data generated.

Since matrix elements to be output by the learning model M100 are narrowed down to four elements by confinement to linear transformation, the amount of learning data can be largely reduced, and the time required for learning by a learning model can be largely reduced.

### Specific Example 2

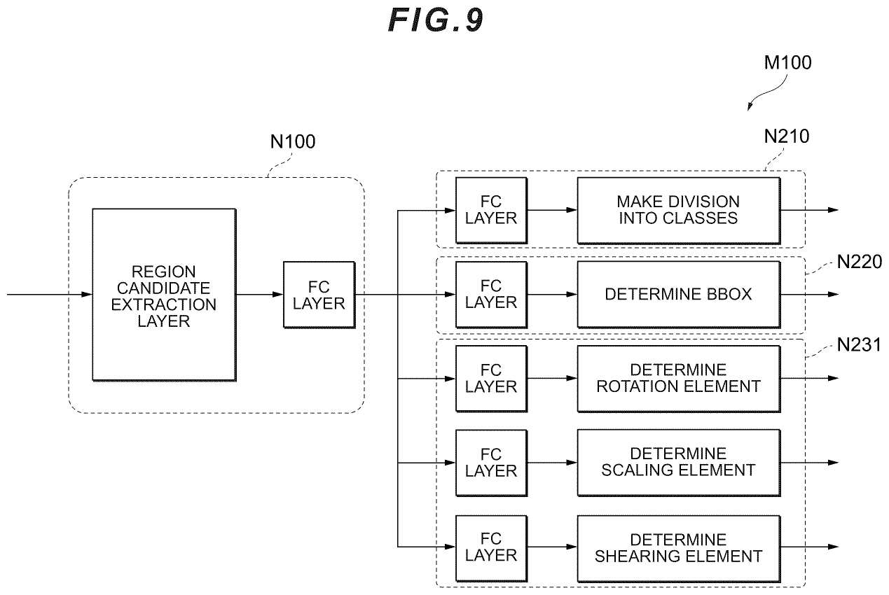

FIG. 9 is a diagram showing a learning model (specific example 2). When an image is input into the network N100, the learning model M100 in specific example 2 outputs, as projective transformation information, an element representing rotation, an element representing scaling (scaleup or scaledown), and an element representing shearing in homography matrices from a network N231 which is connected to the network N100. The network N210 and the network N220 are the same as in specific example 1. In specific example 2, the network N100 and the network N231 may be called a first network and a second network, respectively. The network N210 and the network N220 may be called a third network and a fourth network, respectively.

That is, the network N231 (the second network) in specific example 2 may include at least one or more of a network which outputs an element of a homography matrix related to rotation, a network which outputs an element of a homography matrix related to scaling, and a network which outputs an element of a homography matrix related to shearing. When an image is input into the network N100, the learning model M100 may output, as information related to projective transformation, an element of a homography matrix related to at least one or more of rotation, scaling, and shearing which is estimated to have been applied to a logo (target of detection) before the projective transformation from the network N231 connected to the network N100.

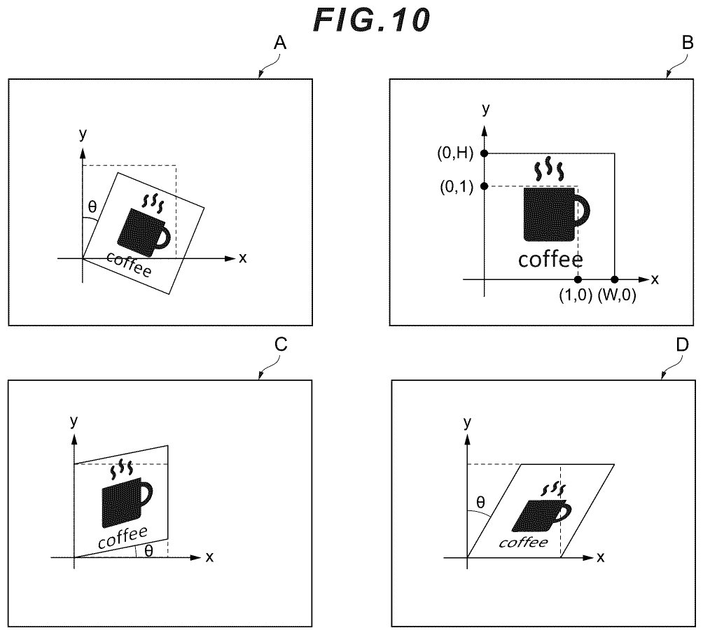

FIG. 10 is a view showing four patterns of projective transformation. Reference character A in FIG. 10 denotes an example of a case where a logo is rotated clockwise by θᵣₒₜ degrees. A homography matrix in this case is represented by Expression 5.

$$[ Expression 5 ]$$

$$H = [ \begin{matrix}cos {θ}_{rot} & - sin {θ}_{rot} & 0 \\ sin {θ}_{rot} & cos {θ}_{rot} & 0 \\ 0 & 0 & 1\end{matrix} ] \qquad ( 5 )$$

Reference character B in FIG. 10 denotes an example of a case where the logo is scaled up or down in a y-axis direction or an x-axis direction. A homography matrix in a case where the logo is scaled up H/1 times in the y direction and scaled up W/1 times in the x direction is represented by Expression 6.

$$[ Expression 6 ]$$

$$H = [ \begin{matrix}W & 0 & 0 \\ 0 & H & 0 \\ 0 & 0 & 1\end{matrix} ] \qquad ( 6 )$$

Reference character C in FIG. 10 denotes an example of a case where the logo is sheared by θ_{shear_y} degrees in the y-axis direction. A homography matrix in this case is represented by Expression 7.

$$[ Expression 7 ]$$

$$H = [ \begin{matrix}1 & 0 & 0 \\ tan {θ}_{shear \_ y} & 1 & 0 \\ 0 & 0 & 1\end{matrix} ] \qquad ( 7 )$$

Reference character D in FIG. 10 denotes an example of a case where the logo is sheared θ_{shear_x} degrees in the x-axis direction. A homography matrix in this case is represented by Expression 8.

$$[ Expression 8 ]$$

$$H = [ \begin{matrix}1 & tan {θ}_{shear \_ x} & 0 \\ 0 & 1 & 0 \\ 0 & 0 & 1\end{matrix} ] \qquad ( 8 )$$

The learning model M100 may output a value of θᵣₒₜ as an element of a homography matrix related to rotation, output values of W and H as elements of a homography matrix related to scaling, output a value of θ_{shear_y} as an element of a homography matrix related to shearing in the y direction, and output a value of θ_{shear_x} as an element of a homography matrix related to shearing in the x direction. The learning model M100 may output, as a value corresponding to unrelated deformation of the above-described output values, a value (e.g., 0 degrees for θᵣₒₜ, 1 for W, 1 for H, 0 degrees for θ_{shear_y}, or 0 degrees for θ_{shear_x}) indicating absence of deformation. For example, if deformation in a logo is rotation alone, the learning model M100 may output the value (e.g., 10 degrees or 45 degrees) of θᵣₒₜ corresponding to a rotation angle, output 1 and 1 as the values of W and H, output 0 as the value of θ_{shear_y}, and output 0 as the value of θ_{shear_x}. Similarly, if deformation in the logo is scaleup in the y direction alone, the learning model M100 may output 0 as the value of θᵣₒₜ, output a post-scaleup value (e.g., 1.5 or 2) as the value of W, output 1 as the value of H, output 0 as the value of θ_{shear_y}, and output 0 as the value of θ_{shear_x}.

Learning by the learning model M100 in specific example 2 may be performed by the following procedure. First, the learning unit 104 randomly generates a value of θᵣₒₜ, a value of W, a value of H, a value of θ_{shear_y}, and a value of θ_{shear_x}. The learning unit 104 then generates a homography matrix by multiplying a matrix represented by Expression (5), a matrix represented by Expression (6), a matrix represented by Expression (7), and a matrix represented by Expression (8). The learning unit 104 generates an image obtained by combining a logo image which is projectively transformed using the generated homography matrix with a background image without the logo image. The learning unit 104 generates learning data which has the generated image as input data and has, as output data, class information corresponding to the logo image, a position of a BBOX indicating a region where the logo image is present in the image, and the value of θᵣₒₜ, the value of W, the value of H, the value of θ_{shear_y}, and the value of θ_{shear_x} used at the time of the projective transformation of the logo image. Note that the class information and the position of the BBOX may be designated by a user who generates the learning model. The learning unit 104 generates a large number of learning data by repeating the process of generating learning data.

The learning unit 104 causes the learning model M100 to learn using the large number of learning data generated. Although, for example, RMSLE using a mean squared error may be used as a loss function used for learning, the loss function is not limited to this.

Note that if a pattern of logo deformation is limited to any one of rotation, scaling in the y-axis direction, scaling in the x-axis direction, shearing in the y-axis direction, and shearing in the x-axis direction, the learning unit 104 may generate learning data by varying only any one of a value of θᵣₒₜ, a value of W, a value of H, a value of θ_{shear_y}, and a value of θ_{shear_x} and setting the other values to values indicating absence of deformation at the time of randomly generating these values.

According to specific example 2, the amount of learning data can be more largely reduced than in specific example 1, and the time required for learning by a learning model can be more largely reduced.

Note that the information processing apparatus 10 determines rotation, scaleup, scaledown, and shearing as four patterns of projective transformation in specific example 2 described above and that this is synonymous with determination of linear transformation. Thus, the terms “projective transformation” and “projective transformation information” in the description of specific example 2 may be replaced with the terms “linear transformation” and “projective transformation information,” respectively.

### Specific Example 3

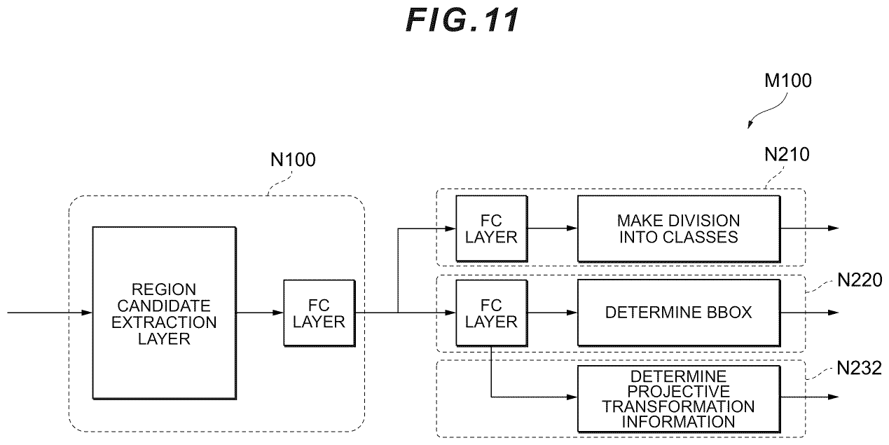

FIG. 11 is a diagram showing a learning model (specific example 3). When an image is input into the network N100, the learning model M100 in specific example 3 outputs, as projective transformation information, coordinates of a plurality of feature points which are present in a logo (target of detection) after projective transformation, the coordinates being relative coordinates to a predetermined reference point, from a network N232. The network N210 and the network N220 are the same as in specific example 1.

The learning model M100 may include the network N210 that is connected to the network N100 and determines a BBOX surrounding a logo (target of detection) from a region candidate for an object and the network N220 that is connected to the network N100 and determines a type of the logo (target of detection) from the region candidate for the object. The network N232 may be connected to the network N220. In this case, the determination unit 102 may determine a BBOX and a type of a target of detection by inputting an image into the learning model, and the output unit 103 may output the BBOX and the type of the target of detection determined by the determination unit 102.

In specific example 3, the network N100 and the network N232 may be called a first network and a second network, respectively. The network N210 and the network N220 may be called a third network and a fourth network, respectively.

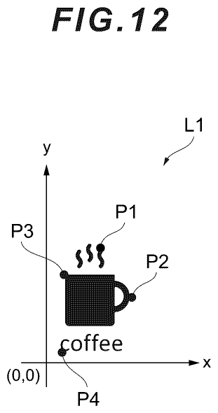

FIG. 12 is a view for explaining feature points of a target of detection. As shown in FIG. 12, positions of relative coordinates (x,y) of four feature points P1 to P4 are determined in advance in the logo L1. Note that a point (0,0) at which the x-axis and the y-axis cross may be set as a reference point, the reference point is not limited to this. An arbitrary point may be adopted as the reference point. The number of feature points is not limited to four. For example, the number of feature points may be three or may be five or more. Although positions of feature points are arbitrarily set, the positions are preferably set to positions as far from the center as possible, such as an upper left end, an upper right end, a lower left end, and a lower right end of a logo.

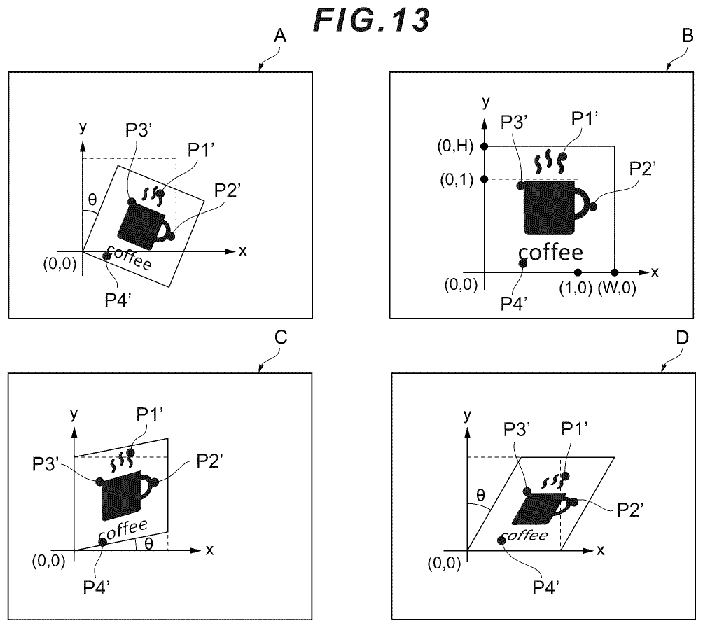

FIG. 13 is a view showing one example of feature points after projective transformation. Relative coordinates of feature points (P1′ to P4′) when the logo is rotated are shown in A of FIG. 13. Relative coordinates of the feature points (P1′ to P4′) when the logo is scaled up or down are shown in B of FIG. 13. Relative coordinates of the feature points (P1′ to P4′) when the logo is sheared in a y direction are shown in C of FIG. 13. Relative coordinates of the feature points (P1′ to P4′) when the logo is sheared in an x direction are shown in D of FIG. 13.

For example, if an image with a logo shown in A of FIG. 13 appearing therein is input, the learning model M100 outputs the relative coordinates of the feature points (P1′ to P4′) shown in A of FIG. 13. Similarly, if an image with a logo shown in D of FIG. 13 appearing therein is input, the learning model M100 outputs the relative coordinates of the feature points (P1′ to P4′) shown in D of FIG. 13.

Learning by the learning model M100 in specific example 3 may be performed by the following procedure. First, the learning unit 104 generates a homography matrix by randomly generating nine elements of Expression 2. The learning unit 104 then generates an image obtained by combining a logo image which is projectively transformed using the generated homography matrix with a background image without the logo image. The learning unit 104 calculates relative coordinates of four feature points in the logo image after the projective transformation. The learning unit 104 generates learning data which has the generated image as input data and has, as output data, class information corresponding to the logo image, a position of a BBOX indicating a region where the logo image is present in the image, and the relative coordinates of the four feature points. Note that the class information and the position of the BBOX may be designated by a user who generates the learning model. The learning unit 104 generates a large number of learning data by repeating the process of generating learning data.

Then, the learning unit 104 causes the learning model M100 to learn using the larger number of learning data generated. Although, for example, RMSLE using a mean squared error may be used as a loss function used for learning, the loss function is not limited to this.

Note that, as described in specific example 1, the determination unit 102 may determine only deformation which is linear transformation. In this case, the terms “projective transformation” and “projective transformation information” in the description of specific example 3 may be replaced with the terms “linear transformation” and “projective transformation information,” respectively. At the time of causing the learning model M100 to learn, the learning unit 104 may generate a homography matrix or a matrix related to linear transformation by randomly generating four elements (h11 to h22 in Expression 2 or l11 to l22 in Expression 4) and generate a logo image which is linearly transformed using the generated matrix. Respects which are not particularly referred to may be identical to those in the description of the learning procedure in specific example 3 described above.

As shown in FIG. 11, in the learning model M100 in specific example 3, the network N232 is connected not to the network N100 but to an FC layer of the network N220. Since the network N220 is a network which determines a BBOX, there is a high possibility that some information for estimating a position of a BBOX is extracted at the FC layer of the network N220. Thus, a part of processing that estimates a position of a target of detection in an image can be shared by connecting the network N232 to the FC layer of the network N220. As a result, network arguments can be more reduced than in the learning model M100 in specific example 1, and a learning time can be reduced.

### CONCLUSION

According to the above-described embodiment, it is possible to more appropriately determine whether a target of detection is deformed by determining projective transformation information from a shot image of the target of detection.

The above-described embodiment is intended to facilitate understanding of the present invention and is not intended to restrictively interpret the present invention. The flowcharts and sequences described in the embodiment, the elements included in the embodiment, and the arrangement, the materials, the conditions, the shapes, the sizes, and the like of the elements are not limited to those illustrated and can be appropriately changed. Components illustrated in different embodiments can be partially replaced with or combined with each other.

Since linear transformation is one example of projective transformation, linear transformation information may be included in projective transformation information according to the present embodiment.

### SUPPLEMENTARY NOTES

The present embodiment may be expressed in the manners below.

### <Supplementary Note 1>

An output apparatus including
an acceptance unit which accepts input of a shot image of a target of detection,
a determination unit which determines information related to projective transformation of the target of detection by inputting the image into a learning model, and
an output unit which outputs the information related to the projective transformation determined by the determination unit.

### <Supplementary Note 2>

The output apparatus according to supplementary note 1, wherein
the learning model is a neural network including a first network which extracts a region candidate for an object appearing in the input image and a second network which outputs the information related to the projective transformation of the target of detection from the region candidate for the object, and
the determination unit determines the information related to the projective transformation by inputting the image into the neural network.

### <Supplementary Note 3>

The output apparatus according to supplementary note 2, wherein
the neural network outputs, as the information related to the projective transformation, an element of a homography matrix which is estimated to have been applied to the target of detection before the projective transformation from the second network that is connected to the first network when the image is input into the first network.

### <Supplementary Note 4>

The output apparatus according to supplementary note 2, wherein
the second network includes at least one or more of a network which outputs an element of a homography matrix related to rotation, a network which outputs an element of a homography matrix related to scaling, and a network which outputs an element of a homography matrix related to shearing, and
the neural network outputs, as the information related to the projective transformation, an element of a homography matrix related to at least one or more of rotation, scaling, and shearing which is estimated to have been applied to the target of detection before the projective transformation from the second network that is connected to the first network when the image is input into the first network.

### <Supplementary Note 5>

The output apparatus according to supplementary note 3 or 4, wherein
the neural network includes a third network which is connected to the first network and determines a bounding box surrounding the target of detection from the region candidate for the object and a fourth network which is connected to the first network and determines a type of the target of detection from the region candidate for the object,
the determination unit determines the bounding box and the type of the target of detection by inputting the image into the neural network, and
the output unit outputs the bounding box and the type of the target of detection determined by the determination unit.

### <Supplementary Note 6>

The output apparatus according to supplementary note 2, wherein
the neural network outputs, as the information related to the projective transformation, coordinates of a plurality of feature points which are present in the target of detection after the projective transformation, the coordinates being relative coordinates to a predetermined reference point, from the second network when the image is input into the first network.

### <Supplementary Note 7>

The output apparatus according to supplementary note 6, wherein
the neural network includes a third network which is connected to the first network and determines a bounding box surrounding the target of detection from the region candidate for the object and a fourth network which is connected to the first network and determines a type of the target of detection from the region candidate for the object,
the second network is connected to the third network,
   the determination unit determines the bounding box and the type of the target of detection by inputting the image into the neural network, and
   the output unit outputs the bounding box and the type of the target of detection determined by the determination unit.

### <Supplementary Note 8>

The output apparatus according to any one of supplementary notes 1 to 7, including
a learning unit which causes the learning model to learn using teaching data in which a shot image of a target of detection is associated with information related to projective transformation of the target of detection.

### <Supplementary Note 9>

The output apparatus according to supplementary note 1, wherein
the determination unit determines a bounding box surrounding the target of detection and a type of the target of detection by inputting the image, and
the output unit outputs the bounding box and the type of the target of detection determined by the determination unit.

### <Supplementary Note 10>

An output method to be performed by an output apparatus, including
a step of accepting input of a shot image of a target of detection,
a step of determining information related to projective transformation of the target of detection by inputting the image into a learning model, and
a step of outputting the determined information related to the projective transformation.

### <Supplementary Note 11>

A program for causing a computer to execute
a step of accepting input of a shot image of a target of detection,
a step of determining information related to projective transformation of the target of detection by inputting the image into a learning model, and
a step of outputting the determined information related to the projective transformation.

### REFERENCE SIGNS LIST

1 image determination system, 10 information processing apparatus, 11 processor, 12 storage device, 13 network IF, 14 input device, 15 output device, 20 terminal, 100 storage unit, 101 acceptance unit, 102 determination unit, 103 output unit, 104 learning unit, N communication network

1. An output apparatus comprising:
at least one memory configured to store computer program code;
at least one processor configured to operate as instructed by the computer program code, the computer program code including:
acceptance code configured to cause at least one of the at least one processor to accept input of a shot image of a target of detection;
determination code configured to cause at least one of the at least one processor to determine information related to projective transformation of the target of detection by inputting the image into a learning model; and
output code configured to cause at least one of the at least one processor to output the information related to the projective transformation determined.

2. The output apparatus according to claim 1, wherein
the learning model is a neural network including a first network which extracts a region candidate for an object appearing in the input image and a second network which outputs the information related to the projective transformation of the target of detection from the region candidate for the object, and
the determination code is configured to cause at least one of the at least one processor to determine the information related to the projective transformation by inputting the image into the neural network.

3. The output apparatus according to claim 2, wherein
the neural network outputs, as the information related to the projective transformation, an element of a homography matrix which is estimated to have been applied to the target of detection before the projective transformation from the second network that is connected to the first network when the image is input into the first network.

4. The output apparatus according to claim 2, wherein
the second network includes at least one or more of a network which outputs an element of a homography matrix related to rotation, a network which outputs an element of a homography matrix related to scaling, and a network which outputs an element of a homography matrix related to shearing, and
the neural network outputs, as the information related to the projective transformation, an element of a homography matrix related to at least one or more of rotation, scaling, and shearing which is estimated to have been applied to the target of detection before the projective transformation from the second network that is connected to the first network when the image is input into the first network.

5. The output apparatus according to claim 3, wherein
the neural network includes a third network which is connected to the first network and determines a bounding box surrounding the target of detection from the region candidate for the object and a fourth network which is connected to the first network and determines a type of the target of detection from the region candidate for the object,
the determination code is configured to cause at least one of the at least one processor to determine the bounding box and the type of the target of detection by inputting the image into the neural network, and
the output code is configured to cause at least one of the at least one processor to output the bounding box and the type of the target of detection determined.

6. The output apparatus according to claim 2, wherein
the neural network outputs, as the information related to the projective transformation, coordinates of a plurality of feature points which are present in the target of detection after the projective transformation, the coordinates being relative coordinates to a predetermined reference point, from the second network when the image is input into the first network.

7. The output apparatus according to claim 6, wherein
the neural network includes a third network which is connected to the first network and determines a bounding box surrounding the target of detection from the region candidate for the object and a fourth network which is connected to the first network and determines a type of the target of detection from the region candidate for the object,
the second network is connected to the third network,
the determination code is configured to cause at least one of the at least one processor to determine the bounding box and the type of the target of detection by inputting the image into the neural network, and
the output code is configured to cause at least one of the at least one processor to output the bounding box and the type of the target of detection determined.

8. The output apparatus according to claim 1, comprising
learning code configured to cause at least one of the at least one processor to cause the learning model to learn using teaching data in which a shot image of a target of detection is associated with information related to projective transformation of the target of detection.

9. The output apparatus according to claim 1, wherein
the determination code is configured to cause at least one of the at least one processor to determine a bounding box surrounding the target of detection and a type of the target of detection by inputting the image, and
the output code is configured to cause at least one of the at least one processor to output the bounding box and the type of the target of detection determined.

10. An output method to be performed by an output apparatus having at least one processor, the output method comprising:
accepting input of a shot image of a target of detection;
determining information related to projective transformation of the target of detection by inputting the image into a learning model; and
outputting the determined information related to the projective transformation.

11. A computer-readable non-transitory storage medium storing a program configured to cause a computer to:
accept input of a shot image of a target of detection;
determine information related to projective transformation of the target of detection by inputting the image into a learning model; and
output the determined information related to the projective transformation.
